(19) United States
(12) Patent Application Publication
(10) Pub. No.: US 2005/0110418 A1
(43) Pub. Date: May 26, 2005

(54) Command processing device and command processing device control method

(76) Inventors: Takayoshi Fujioka, Yokohama (JP); Nobuyoshi Ando, Kawasaki (JP); Katsumi Kawano, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/970,008

(22) Filed: Oct. 22, 2004

(30) Foreign Application Priority Data
Oct. 24, 2003 (JP) 2003-365151

(51) Int. Cl. G06F 19/00

(52) U.S. Cl. 315/149; 702/107

(57) ABSTRACT

A command processing device includes: a command reception section for receiving command data formed by a plurality of element data by successively receiving the element data; a state transition pattern storage section for storing a processing state transition pattern in the interpretation process of the command data; a state transition section for processing the element data one by one in the interpretation process of the command data and changing the processing state in the interpretation process according to the state transition pattern each time one element data is processed; and a control section for executing control according to the state finally decided by the state transition section.

The present application claims priority from Japanese application JP2003-365151 filed on Oct. 24, 2003, the content of which is hereby incorporated by reference into this application.

### BACKGROUND OF THE INVENTION

The present invention relates to a command processing device and a command processing device control method.

As a method for connecting electronic devices by a cable or radio, various methods such as the Internet Protocol (IP) are standardized and a plenty of electronic devices having a built-in command processing device based on the method are manufactured. Moreover, mounting of the command processing device on various devices is studied such as mobile information devices, mobile telephones, AV (Audio Visual) home electric appliances, house hold appliances, various sensors, facility devices, large computers, and personal computers. Among them, the command processing device for connecting, for example, mobile electronic devices, small-size home electric appliances, and sensors to a network should be of small size and low power consumption.

Moreover, the command processing device mounted on a house hold appliance and a facility device should be arranged at a low cost.

Here, in communication on a network, a message of several bytes or several kilo bytes called packet is passed between the command processing devices. The command processing device transmits/receives the packet, by storing the packet in a variable memory such as RAM (Random Access Memory). For this, the command processing device should include a memory having a sufficient storage capacity for storing the packet. Accordingly, there has been a problem that it is difficult to reduce the power consumption, the size, and the cost. Here, JP-A-2003-99343 discloses a technique for reducing the memory capacity by simplifying processing of a header section among the received communication data.

### SUMMARY OF THE INVENTION

However, according to the technique disclosed in JP-A-2003-99343, although the variable memory area can be saved because the header section in the packet is not stored, the payload section constituting the most of the packet is stored in the variable memory area. Accordingly, this technique is not sufficient for reducing the power consumption, the size, and the cost of the command processing device.

It is therefore an object of the present invention to provide a command processing device and a command processing device control method capable of reducing the capacity of the variable memory to be provided.

In order to attain the aforementioned object, according to an aspect of the present invention, there is provided a command processing device which includes: a command reception section for receiving command data consisting of a plurality of element data transmitted from an information processing device by successively receiving the element data; a state transition pattern storage section for storing processing state transition pattern in the interpretation process of the command data; a state transition section for processing the element data one by one in the interpretation process of the command data and changing the processing state in the interpretation process according to the state transition pattern each time one element data is processed; and a control section for executing control according to the state finally decided by the state transition section.

The command data is, for example, a packet which will be detailed later. The element data is, for example, one-byte data of a byte data string constituting the command data and equivalent. For example, one character which will be detailed later is equivalent to the element data. The state transition pattern in the interpretation process of the command data is, for example, a set of processing states constituting an automaton and expressed, for example, by an algorithm described as a program. The information processing device is, for example, a remote controller for operating a home electric appliance at a distance. The command processing device is, for example, a device built in a home electric appliance for receiving the command data by communication. The control is, for example, control for turning ON/OFF the switch of a home electric appliance such as an illumination device according to the command data transmitted by radio or infrared rays from the remote controller.

According to the present invention, the command processing device changes the state each time element data constituting the command data is processed in the order of reception. Accordingly, the processing device only needs to comprise a memory having a storage capacity for storing a part of a plurality of element data constituting the command data. Thus, it is possible to reduce the power consumption, size, and cost of the command processing device.

Moreover, according to the present invention, the command processing device successively receives element data and successively processes the element data received one by one. Thus, for example, the command processing device can proceed the command data interpretation process while receiving the element data. Moreover, the command processing device can start an interpretation process for the command data without waiting for the end of reception of the command data. Accordingly, it is possible to reduce the time required for processing of the command data interpretation in the command processing device.

According to the present invention, it is possible to provide a command processing device and a command processing device control method capable of reducing the capacity of the variable memory to be provided.

Other objects, features and advantages of the invention will become apparent from the following description of the embodiments of the invention taken in conjunction with the accompanying drawings.

### BRIEF DESCRIPTION OF THE DRAWINGS

FIG. 1 shows configuration of a system using an illumination device as an example of a command processing device according to an embodiment of the present invention.

FIG. 2 is a flowchart showing flow of processing performed at start of the command processing device according to the first embodiment of the present invention.

FIG. 3 shows a state transition pattern of processing of step in the first embodiment of the present invention.

FIGS. 4A, 4B, and 4C show a packet configuration and specific examples capable of deciding control to be performed by the command processing device according to the first embodiment of the present invention.

FIGS. 5A and 5B show a data structure stored in a variable memory according to the first embodiment of the present invention.

FIG. 6 shows a packet configuration and a specific example capable of deciding control to be performed by the command processing device according to the second embodiment of the present invention.

FIGS. 7A, 7B, and 7C shows an example of a valid message in the packet configuration according to the second embodiment of the present invention.

FIG. 8 shows a state transition pattern of processing in the second embodiment of the present invention.

FIGS. 9A, 9B, 9C, 9D, and 9E show data structures stored in a variable memory according to the second embodiment of the present invention.

FIG. 10 is a flowchart showing a flow of processing performed in a state according to the second embodiment of the present invention.

FIG. 11 is a flowchart showing a flow of processing performed in a state according to the second embodiment of the present invention.

### DESCRIPTION OF THE EMBODIMENTS

### Embodiment 1

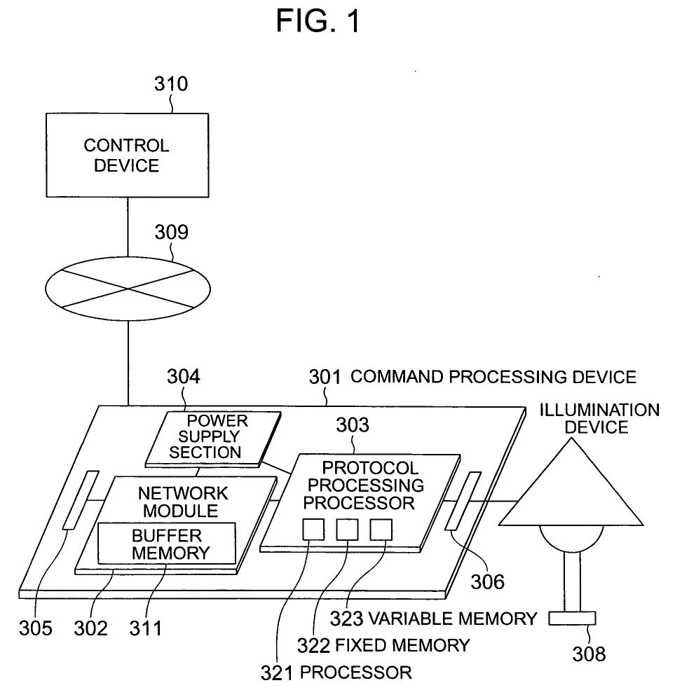

FIG. 1 shows an example of system configuration containing an illumination device connected to the command processing device according to the first embodiment of the present invention. The system includes a control device 310 and a command processing device 301 as an information processing device. The control device 310 is communicably connected to the command processing device 301 by a radio network 309.

The control device 310 is a device for controlling the illumination device 308 by controlling and monitoring the command processing device 301. The control device 310 is specifically, for example, a remote controller for transmitting command data by radio communication such as infrared ray or radio wave. The control device 310 may by a computer such as a personal computer having a CPU and a memory. Moreover, for example, it also may be a dedicated control device for automatically controlling the illumination device by the change of external illuminance.

The command processing device 301 includes a network module 302, a protocol processing processor 303, a power supply circuit 304, an antenna 305, and an interface 306. The command processing device is communicably connected to the illumination device 308 and controls the illumination device 308 via the network.

The network module 302 is connected to the antenna 305 and performs radio communication with the radio network 309. Moreover, the network module 302 has a buffer memory (element data storage section) 311 and stores data received from the radio network 309 in the buffer memory 311. In this embodiment, the buffer memory 311 of the network module 302 has 1-byte storage capacity. When the command processing device 301 receives a packet from the radio network 309, the network module 302 receives data by one byte and stores the received one-byte data in the buffer memory 311.

The protocol processing processor 303 controls the network module 302 and controls transmission/reception of a packet (command data) to/from the radio network 309. Upon packet reception, the protocol processing processor 303 receives data received by the network module 302 and stored in the buffer memory 311 by one byte. The protocol processing processor 303 internally includes a processor 321, a fixed memory 322, and a variable memory 323. The fixed memory 322 is a non-volatile memory such as a ROM and flush memory for storing a program and data. The variable memory 323 is a memory such as an RAM for storing data by the processor 321. The processor 321 reads out the program stored in the fixed memory 322 into the variable memory 323 and executes the read out program, thereby performing interpretation of the command data which will be detailed later and realizing the function of controlling lighting of the illumination device 308.

The power supply circuit 304 supplies power to the respective parts of the command processing device such as the processor 303 and the network module 302.

The antenna 305 emits an electric signal output by the network module 302 as a radio wave or receives a radio wave and inputs it as an electric signal to the network module 302, there by performing data transmission/reception to/from the radio network 309,

The interface 306 mutually converts the electric signal of the processor 321 and the electric signal of the illumination device. In this embodiment, it is a switch for performing ON-OFF control f the power source of the illumination device 308 by the electric signal. The illumination device 308 is an ordinary home electric appliance. The processor 321 controls the interface 306, thereby turning ON and OFF the switch of the illumination device 308.

It should be noted that in this embodiment, the command processing device 301 is connected to the radio network 309 via the antenna 305. However, it is also possible to use an infrared ray emission device and an infrared ray reception device instead of the antenna 305, thereby constituting an infrared ray radio network. Moreover, by using a connector for the network instead of the antenna 305, the command processing device 301 may be connected a communication path by an electric signal such as the Ethernet (trade mark) and the public telephone line. Moreover, instead of the antenna 305 of the command processing device 301, it is possible to use serial communication interface, USB interface, or infrared remote control interface, thereby directly connecting to the control device 310.

Moreover, in this embodiment, the illumination device 308 is connected to the command processing device 301. However, instead of the illumination device, it is also possible to connect house hold appliances such as an air conditioner and a refrigerator, or facility devices such as a sensor, a door, and a switch, or AV devices such as a television.

Moreover, in this embodiment, the interface 306 is a switch controlling ON/OFF of the power source. However, the interface 306 is not limited to this. For example, the interface 306 can be connected to an illumination device 308 of a serial communication interface, a USB interface, an infrared ray remote control interface and serve as an interface for controlling the illumination device 308 by transmitting a command. For example, the processor 321 transmits a command controlling the illumination device 308 via the interface 306 and the illumination device 308 receives the command to operate switch ON/OFF.

Moreover, for example, it is possible to make the interface 306 for radio communication such as infrared ray remote control interface and arrange the command processing device 301 and the illumination device 308 at physically separated positions. Furthermore, the command processing device 301 may be detachably attached to the illumination device 308. For example, by attaching the command processing device 301 onto a device not considering control via the network, the device can be controlled via the network.

Moreover, in FIG. 1, the command processing device 301 is separated from the illumination device 308 but it can be built in the illumination device 308.

Explanation on Processing

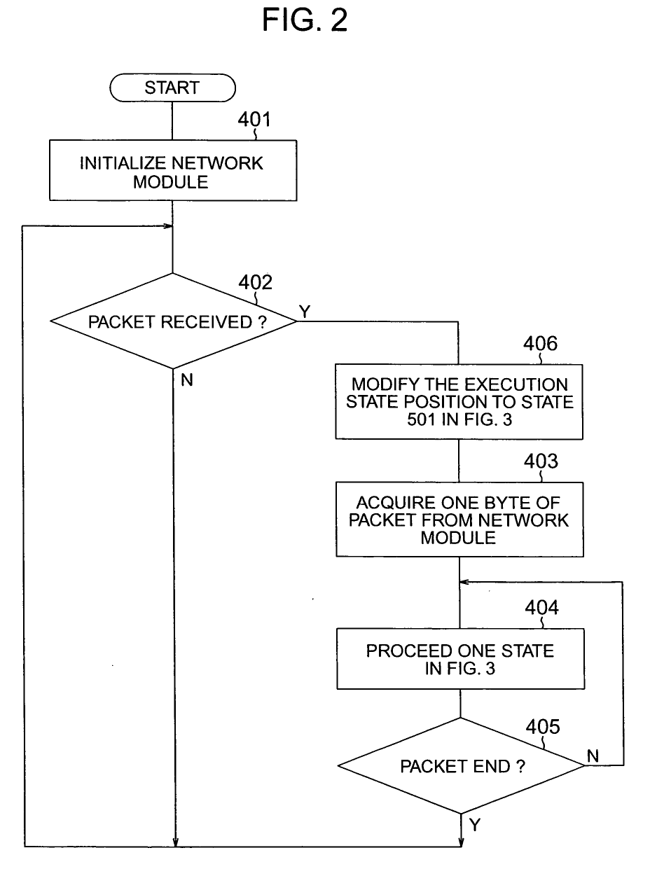

FIG. 2 is a flowchart showing a flow of processes performed upon start of the command processing device 301 in the present embodiment. The processes shown in this flowchart are realized by reading out a program stored in the fixed memory 322 into the variable memory 323 and executing it by the processor 321.

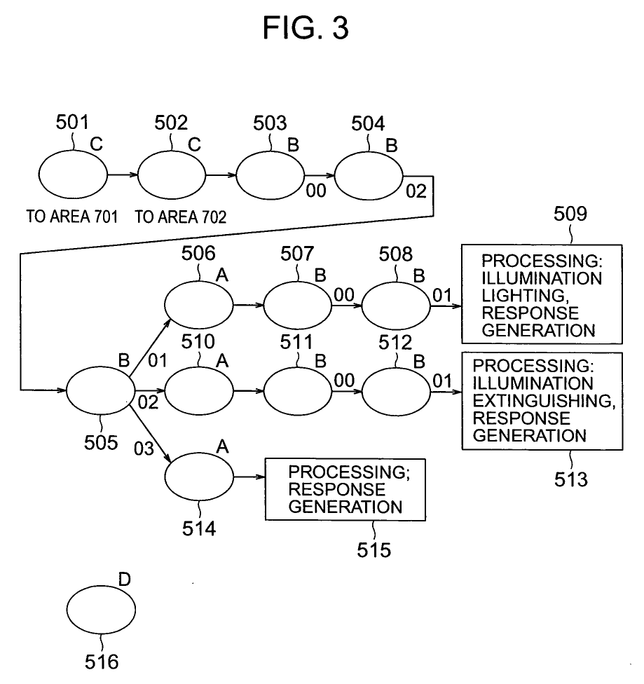

In step 401, a reset signal is transmitted to the network module 302 so as to initialize the network module 302. In step 402, the network module 302 is asked whether packet reception is present. If no packet is received, control is returned to step 402. If a packet is received, control is passed to step 406. In step 406, the current state in the state transition patter which will be detailed later (hereinafter, referred to as an execution state position) is modified to state 501. In step 403, one-byte data (one character) of the packet which has arrived at the network module 302 is received from the network module 302. It should be noted that in this embodiment, explanation is given on that one character is one-byte data but the one character may be an arbitrary length data such as 16-bit, 24-bit, and 32-bit length. In step 404, according to the content of the one character received, the state indicated in FIG. 3 which will be detailed later is changed. In step 405, it is judged whether the one character received is the last character of the packet. If the one character received is the last character of the packet, control is returned to step 402. If the one character received is not the last character, control is passed to step 403 and the aforementioned process is repeated.

FIG. 3 shows a state transition pattern performed in step 404. 501 to 516 represent states in the state transmission pattern. The state transition pattern is expressed by the algorithm contained in the program executed by the aforementioned processor 321. That is, the state transition pattern is stored in the fixed memory 322 (state transition pattern storage section) as the aforementioned program. Information indicating the current state position in the aforementioned state transition patter is stored in the execution state position storage area 703 which will be detailed later. In step 404 of the flowchart shown in FIG. 2, the processor 321 executes only one process corresponding to the state stored in the execution state position storage area 703 which will be detailed later and the state is changed according to the state transition pattern shown in FIG. 3. The process corresponding to the aforementioned state, for example, is realized by reading out the program stored in advance in the fixed memory 322 while being correlated to each state into the variable memory 323 and executing it by the processor 321. Moreover, a table correlating each state, one character received, and the transition destination state is stored in the fixed memory 322, so that the processor 321 can reference the table when necessary. Among programs executed by the processor 321, each state, the process executed according to the character received, and the state transition destination may be built in as the condition branch.

Hereinafter, detailed explanation will be given on the process in each state.

In states 506, 510, 514 indicated by “A” in FIG. 3, only the current state is changed to the next state. For example, when the execution state position is the state 506, only a process for modifying the execution state to state 507 is performed. Similarly, when the execution state position is state 510, only a process for modifying the execution state position to state 511 is performed.

In states 503, 504, 505, 507, 508, 511, and 512 indicated by “B” in FIG. 3, according to the content of the character received, the nest state to be changed is decided. For example, when the execution state position is state 505, if the content of the one character received is “01”, a process for modifying the execution state position to state 506 is executed. If the content of the one character received is “02”, a process for modifying the execution state position to state 510 is executed. If the content of the one character received is “03”, a process for modifying the execution state position to state 514 is executed. If the content of the one character received is other these, a process for modifying the execution state position to state 516 is executed.

Similarly, when the execution state position is state 503, if the content of the one character received is “00”, a process for modifying the execution state position to state 504 is executed. If the content of the one character received is other than this, a process for modifying the execution state position to state 516 is executed.

In FIG. 3, in states 501 and 502 indicated by “C”, the one character received is stored in a predetermined memory area of the variable memory 323 and a process of changing to the next state is executed. Which portion of the memory area stores the received one character differs depending on the state. For example, in state 501, the received one character is stored in area 701 which is the first byte of the transmission source address storage area which will be detailed later and in state 502, the received one character is stored in area 702 which is the second byte of the transmission source address storage area which will be detailed later. For example, when the execution state position is state 501, the received one character is stored in area 701 which is the first byte of the transmission source address storage area and the execution state position is modified to state 502. Similarly, when the execution state position is state 502, the received one character is stored in area 702 which is the second byte of the transmission source address storage area and the execution state position is modified to state 503.

In state 516 indicated by “D” in FIG. 3, no state transition destination is present and no process is executed. When the execution state position becomes state 516, the command processing device 301 skips the remaining characters of the packet and executes nothing. Thus, when the command processing device 301 receives an error packet such as a packet containing not expected data, it is possible to prevent trouble such as malfunction.

In FIG. 3, states 509, 513, 515 are the states finally decided as a result of state transmission. Within the frame of states 509, 513, 515, control executed in these states is indicated. In state 509, the illumination device 308 is lit via the interface 306, and response is generated and transmitted to the network module 302, thereby returning response to the control device 310 as a transmission source. In state 513, the illumination device 308 is extinguished via the interface 306, and response is generated and transmitted to the network module 302, thereby returning response to the control device 310 as the transmission source. In state 515, a response is generated and transmitted to the network module 302, thereby returning response to the control device 310 as a transmission source.

Configuration of Packet

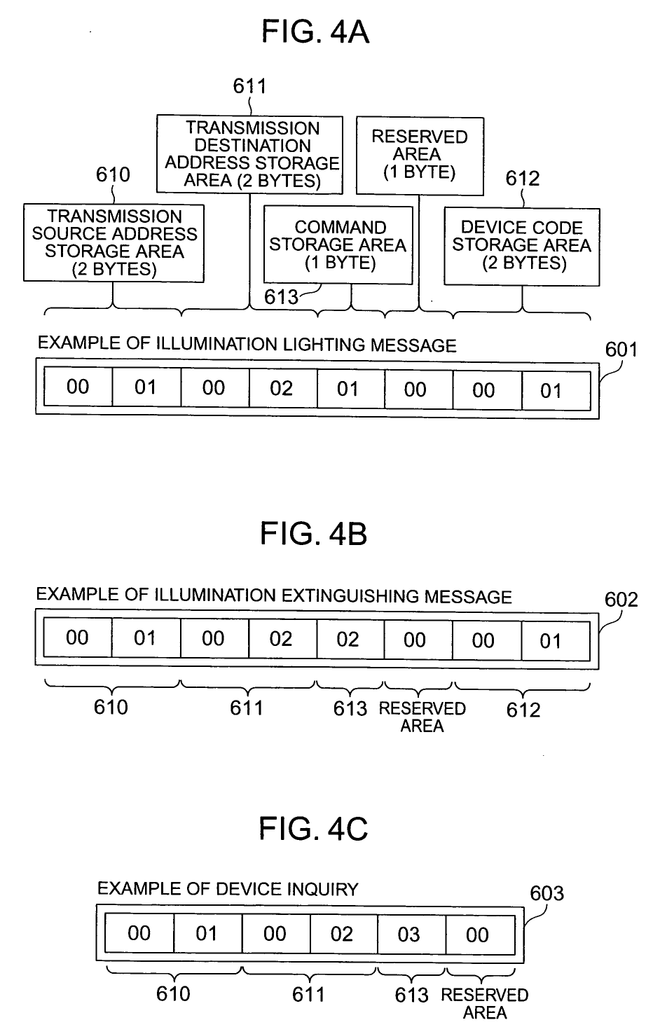

FIGS. 4A, 4B, and 4C show specific examples of a packet capable of deciding control to be performed by the command processing device 301. A packet 601 is a packet for lighting the illumination device 308. A packet 602 is a packet for extinguishing the illumination device 308. A packet 603 is a packet for asking whether the device connected to the command processing device 301 is an illumination device.

A transmission source address storage area 610 stores a transmission source address. In this embodiment, the address indicating the control device 310 is “0001” and this address is stored as a transmission source in the transmission source address storage area 610. A transmission destination address storage area 611 stores a packet transmission destination address. In this embodiment, the address indicating the command processing device is “0002”. This address is stored as the transmission destination in the transmission destination address storage area 611. A device code storage area 612 stores a device code indicating the type of the device as a packet transmission destination. In this embodiment, the device code “01” indicates that the illumination device 308 is an illumination apparatus. It should be noted that the packet 603 asking whether the device is an illumination apparatus can omit the device code storage area 612. The command storage area 613 contains a value indicating control to be processed. In this embodiment, the illumination lighting is “01” and extinguishing is “02”.

For example, when the command processing device 301 has received the packet 602, each time steps 403, 404, and 405 in the flowchart of FIG. 2 are repeated, the execution state position shown in FIG. 3 is successively changed from 501 to 502, 503, 504, 505, 510, 511, 512, and 513. Thus, control decided in accordance with state 513, that is, extinguishing the illumination is executed.

For example, for the transmission destination address storage area 611 containing the transmission destination address, the transmission destination address is other than “0002” which is the network address indicating the command processing device 301 such as a case when a packet containing “0103” is received by the command processing device 301, the execution state positions shown in FIG. 3 is changed from 501 to 502, 503, 516, 516, 516, 516 each time steps 403, 404, 405 in the flowchart of FIG. 2 are repeated once. That is, when the command processing device 301 receives this packet, no control is performed to operate the illumination.

Thus, by combination of the methods indicated in FIG. 2 and FIG. 3, the command processing device 301 can correctly interpret the command stored in the packet shown in FIG. 4.

It should be noted that the command processing device 301 stores in advance the device code of the illumination device 308 connected in the fixed memory 322 and the variable memory 323. The command processing device 301 transmits the device code stored in advance to the control device 310 in the “response generation” process in the state 515. However, the command processing device 301 can communicably connect the illumination device 308 via the interface 306 so that the device code can be acquired from the illumination device 308. In this case, the command processing device 301 transmits a command asking the device code to the illumination device 308 and receives the response to acquires the device code of the illumination device 308, so that the acquired device code is stored in the variable memory 323.

Data Structure

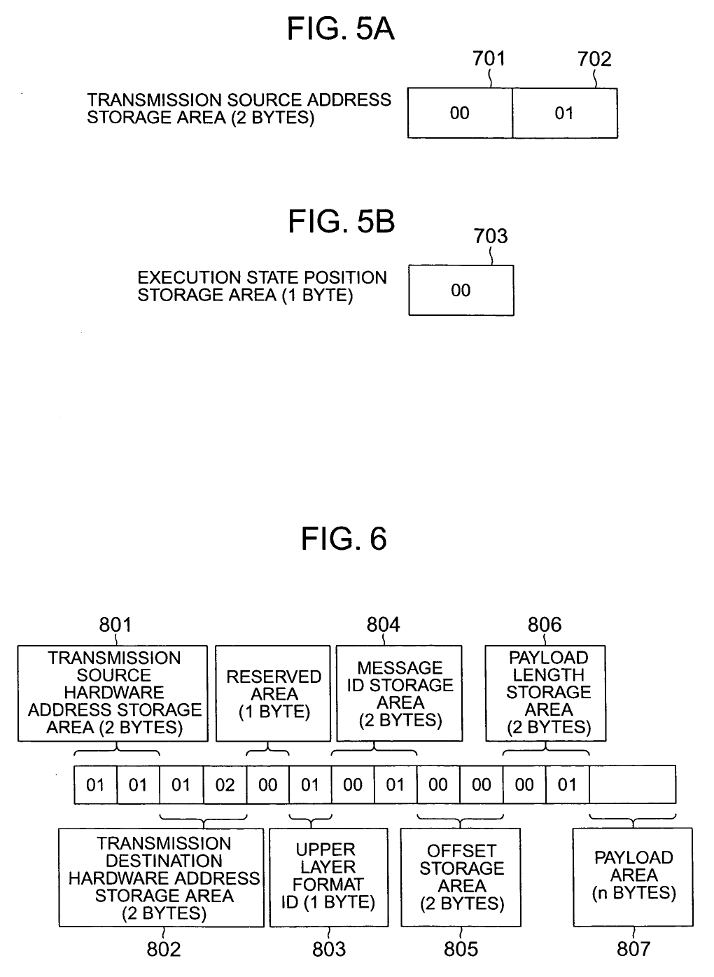

FIGS. 5A and 5B show a data structure stored in the variable memory 323 in the processing shown in FIG. 2 and FIG. 3 in this embodiment.

The transmission source address storage area has a 2-byte size serving as an area used for storing data stored in the packet data transmission address storage area 610. The area has an area 701 as the first byte from the head and the an area 702 as the second byte from the head. The area 701 stores one character received from the packet which has arrived at the network module 302 in step 403 in FIG. 2. Moreover, the area 702 stores one character received from the packet which has arrived at the network module 302.

The execution state position storage area 703 has a one-byte size used for storing the execution state position information when executing the processing shown in FIG. 3, i.e., information on the current state position on the state transition pattern. Each time steps 403, 404, and 405 in the flowchart of FIG. 2 are repeated, the execution state position storage area 703 is referenced and modified. In this embodiment, since the number of states in the transition pattern is not greater than 256, 1-byte size is used as a sufficient size for expressing each of them as an independent code. The size of the execution state position storage area 703 is not to be limited to this. It can be an area of an arbitrary size such as a 2-byte, 3-byte, 4-byte, or 8-byte size. Moreover, as the state position information, it is possible to use a pointer indicating the address of the memory containing the program executed in each step. By using the address of the memory containing the program as the state position information, the processor 321 can easily and rapidly execute a process in accordance with the state.

As has been described above, the command processing device 301 changes the state each time element data constituting the command data is processed in the sequence of the reception order. That is, each time the network module 302 receives one character, the processor 321 can receive and process one character. Accordingly, the command processing device 301 needs a memory having only a storage capacity for storing a part of a plurality of characters (element data) constituting the command data. For example, the buffer memory 311 for temporarily storing the data received by the network module 302 needs to store only one character. Consequently, it is possible to reduce the power consumption, size, and cost of the command processing device 301. Moreover, the command processing device 301 successively receives the character (element data) and successively processes the received character one by one. Thus, for example, the command processing device 301 can execute interpretation of the command data while receiving each character. Moreover, the command processing device 301 can start interpretation of the command data without waiting for the end of reception of the command data. Accordingly, it is possible to reduce the time required for interpretation of the command data by the command processing device.

In general, in the process of receiving a packet in the command processing device 301, the packet received is temporarily copied in the variable memory 323 and after this, process for the packet stored in the variable memory 323 is executed. In this method, for example, in order to execute packet processing in the packets 601, 602, and 603, 3-byte memory is required. However, in the embodiment shown in FIG. 2 and FIG. 3, there is no need of storage area of the variable memory 323 for holding the entire length of the packet. The total number of bytes required is only three: two bytes of the transmission source address storage areas (701 and 702) and one byte of execution state position storage area (703). Thus, it is possible to reduce the capacity of the variable memory 323 to be owned by the command processing device 301.

Moreover, in the communication of the command processing device 301, generally, the size of the packet to be received is not known in advance. Accordingly, the command processing device 301 should consider the case when the packet received is an invalid packet having a size larger than the receivable maximum size. When the command processing device 301 receives a packet and copies the entire length of the packet in the variable memory 323, for example, if a packet of 9 bytes or more is received when the packet memory size is only 8 bytes, a so-called buffer overflow is generated. That is packet data is written in the ninth address which is not the correct area for storing the packet. Thus, the command processing device which has received an invalid packet may malfunction. This is currently a problem often caused in existing network devices as a security hole. To cope with this problem, there is used a method that a memory for storing a maximum packet size passed by the network module 302 is arranged in the variable memory and all the packets are transferred into the area. As a result, a great amount of variable memory is required.

However, in the command processing device 301 of the present embodiment, the packet is not entirely copied in the variable memory 323. Moreover, when writing the received data into the memory, the data is written into a predetermined address such as the transmission source address storage areas 701, 702 without writing data into a relative address starting at the area head. Accordingly, the problem of buffer flow does not occur.

Furthermore, in the general method, after the entire packet is received the packet interpretation is started. However, in this method, when packet start data is received, packet interpretation is immediately started. Accordingly, it is possible to reduce the time from the packet reception until the control operation for the illumination device 308 in the command processing device 301. Especially when a small-size processor is used, the number of instructions which can be processed in a unit time is small as compared with a large-size processor. Accordingly, when the general method is used in the small-size processor, since no packet interpretation is performed while the entire packet is received, response time may be too long. However, by using the method of the present invention, while the packet is received, interpretation of the packet is performed in parallel. Accordingly, the it is possible to effectively operate the processor 321 and it is possible to obtain a sufficiently rapid response time even in a small-size processor.

### Embodiment 2

Next, as a second embodiment, explanation will be given on a command processing device 301 of the present invention which can perform a complicated protocol than the first embodiment, i.e., processing of a more complicated format. In this embodiment, the configuration of the command processing device 301 is identical to the configuration of the first embodiment shown in FIG. 1 but the program stored in the fixed memory 322 is different.

A general protocol such as TCP/IP (Transmission Control Protocol/Internet Protocol) is composed of a plurality of protocol layers and a payload portion in a lower protocol packet generally stores the packet defined by the upper node protocol.

Packet Configuration

FIG. 6 shows a packet configuration which can decide control to be performed by the command processing device 301 in this embodiment. This packets are the various packets shown in FIG. 4: packet 601 for lighting the illumination, packet 502 for extinguishing the illumination, and packet 603 asking whether the device is an illumination device.

The transmission source hardware address storage area 801 contains a transmission source hardware address. In this embodiment, the transmission source hardware address is “0101”. The transmission destination hardware address storage area 802 contains the transmission destination hardware address. In this embodiment, the hardware address indicating the command processing device 301 is “0102”. This address is contained in the transmission destination hardware address 802.

The upper node layer format ID 803 contains an upper node layer format ID. The upper node layer format ID is an identifier for identifying the protocol defining the upper node layer packet stored in the payload portion. In this embodiment, the upper node layer is a protocol defining the various packets shown in FIG. 4. “01” is assigned as an ID (identifier) of the protocol.

The message ID storage area 804 is an area for storing the message ID. The message ID is an identifier for identifying the upper node layer packet. In general, a lower node protocol permits to divide the upper node packet when transmitting it. In this embodiment also, the data sequence of the various packets shown in FIG. 4 can be stored in a plurality of packets when transmitted. When a packet is divided into a plurality of packets, the same value is used as an identifier for the data which has been the same packet and a different value as an identifier for the data which has been another packet, so that they can be assembled into the original packets.

The offset storage area 805 stores an offset value. When a packet is divided into a plurality of parts, the offset value indicates the N-th byte of the divided packet counted from the head before the division (offset amount).

The payload length storage area 806 stores a value indicating the size of the payload area 807. The payload area 807 is an area for storing the upper node layer packet. In this embodiment, the data sequence of the various packets shown in FIG. 4 is stored as it is or divided and a part is stored.

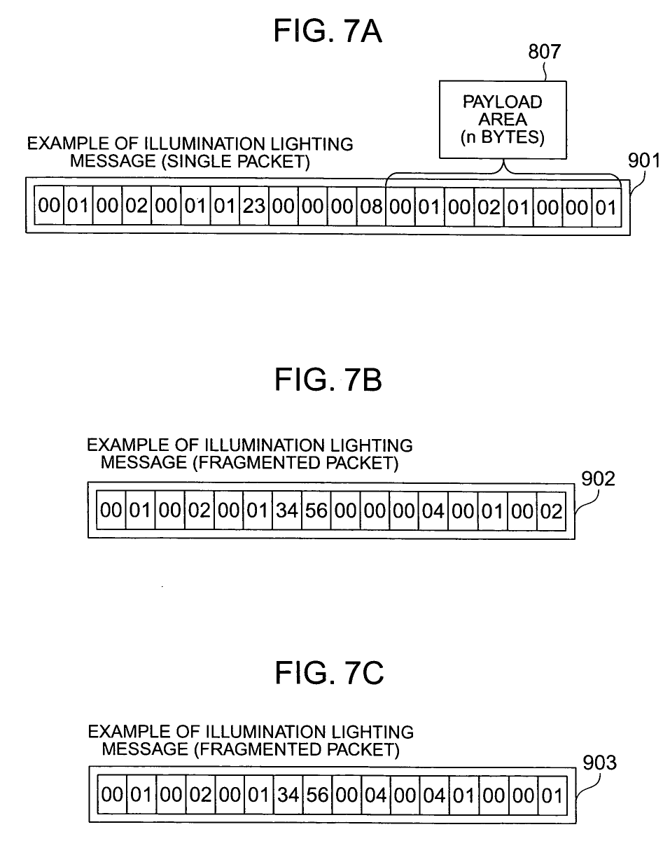

FIGS. 7A, 7B, and 7C show examples of a valid message in the packet configuration in this embodiment. The illumination lighting message 901 by a single packet is a packet having an illumination lighting message 601 in the payload area 807. The payload length stored in the payload length storage area 806 is the size “8” of the illumination lighting message 601, i.e., “00-08”. The offset amount stored in the offset storage area 805 is “0” since the illumination lighting message 601 is stored in this packet payload starting at the head, i.e., “00-00”. Moreover, the “01-23” set in the message ID storage area 804 is a message ID of the packet 901. By this message ID, the command processing device 301 can distinguish the packets 902 and 903 as different packets.

When the illumination lighting message 601 shown in FIG. 4 is divided into two parts: the illumination lighting messages 902 and 903 by a plurality of packets are respectively the packet of the head 4-byte data stored in the payload area 807 and the packet of the 4-byte data excluding the head 4-byte data stored in the payload area 807.

In the illumination lighting message 902 by a plurality of packets, the payload length stored in the payload length storage area 806 is “4”, i.e., “00-04”. The offset amount stored in the offset storage area 805 is “X0”, i.e., “00-00” since the illumination lighting message 601 is stored in the packet payload starting at the head. Moreover, the message ID storage area stores “34-56”. This is the same value as the value stored inn the subsequent packet 903. This value indicates that these two packets are originally one packet. In the illumination lighting message 903 by a plurality of packets, the payload length stored in the payload length storage area 806 is “4”, i.e., “00-04”. The offset amount stored in the offset storage area 805 is “4”, i.e., “00-04” since the illumination lighting message 601 is stored in this packet payload, starting at the 4-th byte.

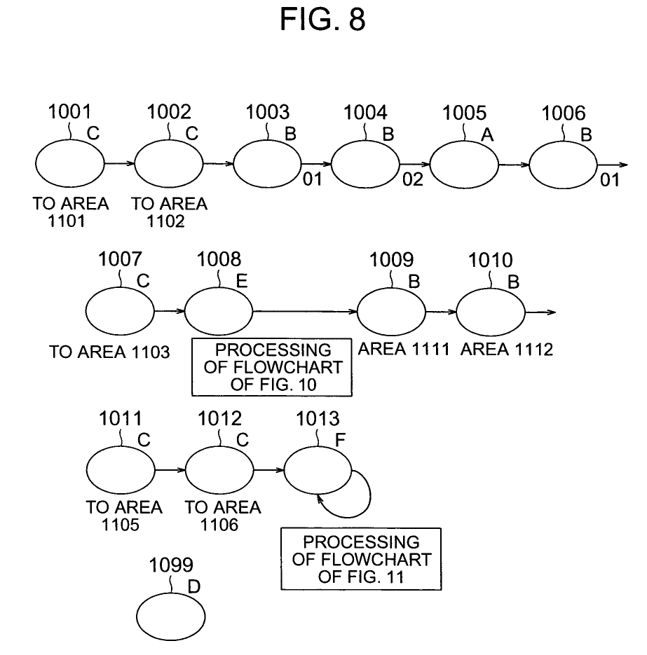

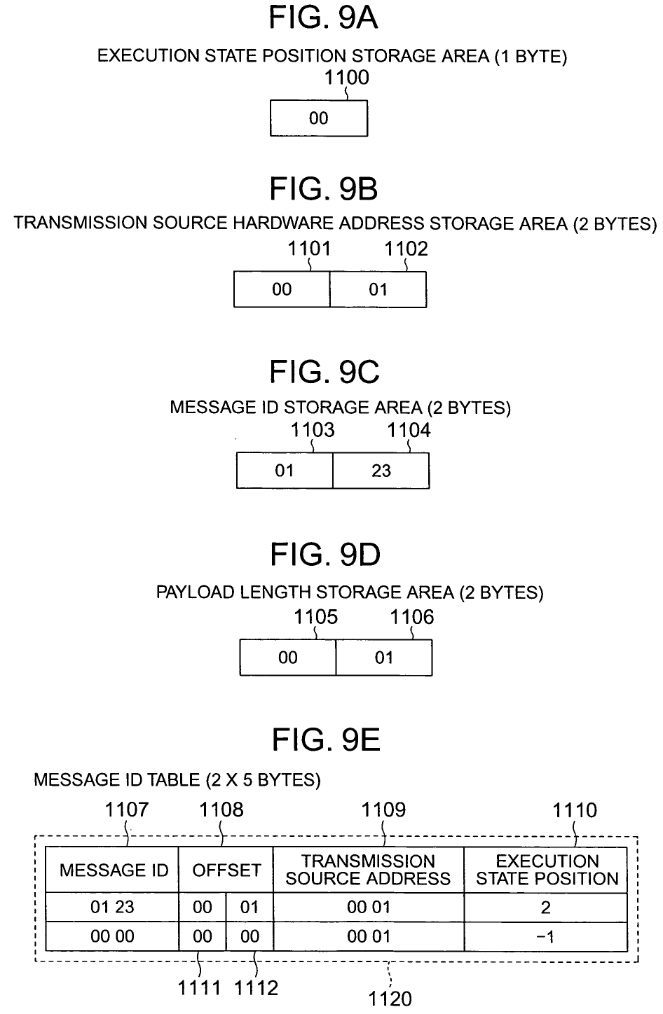

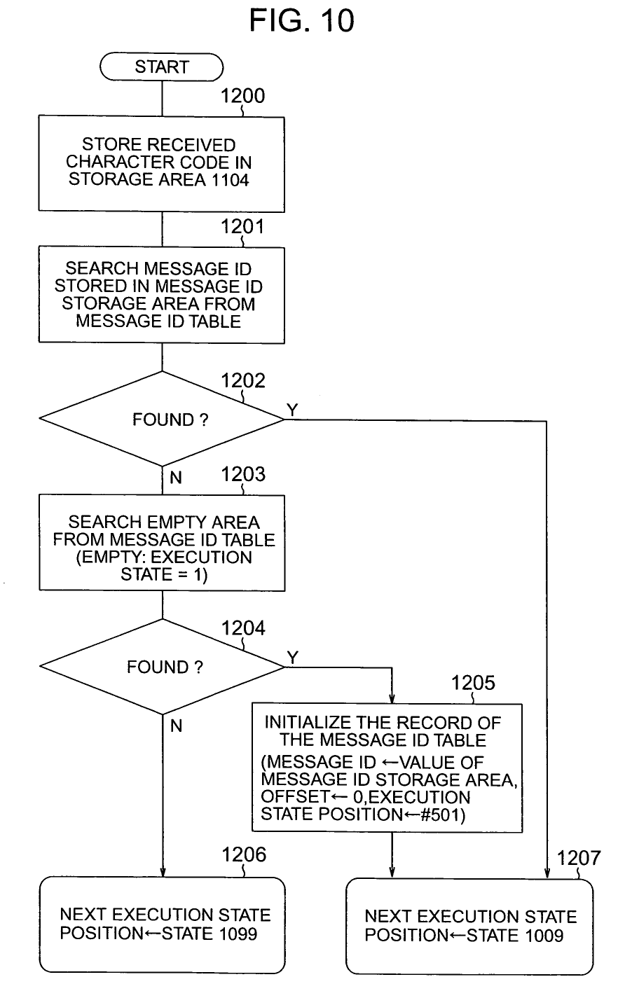

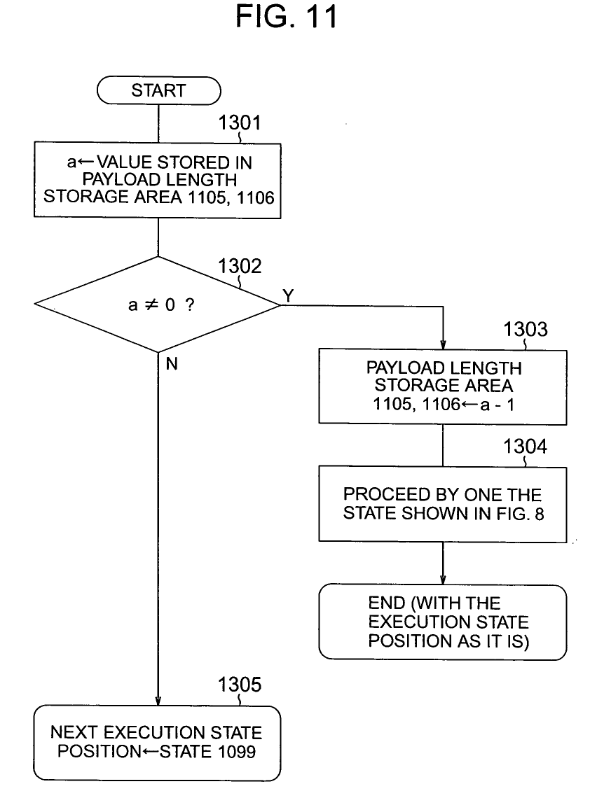

The command processing device 301 in this embodiment can execute processing of such a complicated packet data configuration. The flow of processing of the program stored in the fixed memory 32 is identical to the flowchart shown in FIG. 2. However, in step 406, the execution state position information is modified to state 1001. In step 404, the processing shown in FIG. 8 is executed.

FIG. 8 shows the processing state transition pattern in step 404 of FIG. 2.

In FIG. 8, the sate 1005 indicated by “A” performs simply to change the current state to the next state.

In FIG. 8, the states 1003, 1004, 1006, 1009, and 1010 indicated by “B” decide the state to which the state is changed according to the content of the character received. That is, for example, when the execution state position is state 1003 and if the content of the one character received is “01”, the execution state position is modified to state 1004. Otherwise, the execution state position is modified to state 1099.

In FIG. 8, the states 1001, 1002, 1103, 1011, and 1012 indicated by “C” stores the received character in a predetermined memory area of the variable memory 323 and performs processing to change to the next state. The memory area where the received character is stored differs depending on the state. For example, if state 1001, the received character is stored in area 1101 which is the first byte of the transmission source hardware address storage area which will be detailed later.

In FIG. 8, the state 1099 indicated by “D” performs no processing. In FIG. 8, the state 1008 indicated by “E” performs the processing of the flowchart shown in FIG. 10. In FIG. 8, the state 1013 indicated by “F” performs the processing of the flowchart shown in FIG. 11.

Data Structure

FIGS. 9A, 9B, 9C, 9D, and 9E show data structures stored in the variable memory 232 in this embodiment.

The execution state position storage area 1100 has one-byte size for storing information indicating the current state position on the state transmission patter shown in FIG. 8. The transmission source hardware address storage areas 1101, 1102 have two-byte size for storing transmission source hardware address in a packet. This value is normally required in response processing or the like. The message ID storage areas 1103, 1104 have two-byte size for storing a packet message ID. The payload length storage areas 1105, 1106 have two-byte size for storing payload length in a packet, performs subtraction each time a packet is processed, and are used as a remaining size to be processed.

The message ID table 1120 is a data table consisting of a record having items of a message ID 1107, an offset 1108, a transmission source address 1109, and an execution state position 1110. The message ID table 1120 is a table containing the information on the packet which has been already received when a packet is divided and the head portion packet has been received and the a subsequent packet is not received. The message ID 1107 and the offset 1108 respectively correspond to the message ID storage area 804 and the offset storage area 805 of the packet. The transmission source address 1109 and the execution state position 1110 respectively correspond to the transmission source address storage areas 701, 702 and the execution state storage area 703.

FIG. 10 is a flowchart showing the flow of the processing performed in state 1008. This processing is also realized by execution of the program stored in the fixed memory 322 by the processor 321.

In step 1200, the received one character is stored in the storage area 1104. In step 1201, the message ID stored in the message ID storage areas 1103, 1104 is read out and this value is searched from the message ID table. If the message ID is found in step 1202, control is passed to step 1207. Otherwise, control is passed to step 1203.

In step 1203, an empty record of the message ID table 1120 is searched. In the message ID table 1120, for the empty record, an invalid value is set in the execution state position 1110. In this embodiment, the invalid value indicating empty is “−1”. Moreover, in order to indicate the empty record in the message ID table 1120, an in-use flag may be set in the record so that the value set in the in-use flag indicates whether the record is empty.

If an empty record is found in step 1204, control is passed to step 1205. Otherwise, control is passed to step 1206.

In step 1205, the empty record found is initialized. That is, in the message ID area 1107, the message ID stored in the message ID storage areas 1103, 1104 is set, and “0” is set in the offset area. Moreover, a value indicating the state 501 is set in the executions state position area 1110.

In step 1206, the execution state position is modified to state 1099. That is, a value indicating the state 1099 is set in the execution state storage area 1100. In step 1207, the execution state position is modified to state 1009. That is, a value indicating the state 1009 is set in the execution state storage area 1100.

FIG. 11 is a flowchart of the processing performed in state 1013. This processing is also realized by execution of the program stored in the fixed memory 322 by the processor 321.

In step 1301, the value stored in the payload storage areas 1105, 1106 is read out. It is assumed that the read out value is “a”. Inn step 1302, “a” and “0” is compared. If they are identical, control is passed to step 1305. Otherwise, control is passed to step 1303.

In step 1303, the result of calculation “a −1” is stored in the payload storage areas 1105, 1106. That is, the value stored in the payload storage areas 1105, 1106 is subtracted by “1”. In step 1304, according to the state transition patter shown in FIG. 3, the state is changed by one. However, in this embodiment, in the state transition pattern in FIG. 3, the processing for referencing or modifying the transmission source address storage areas 701, 702 and the execution state position storage area 703 are replaced by the processing for referencing or modifying the transmission source address 1109 of the record of the message ID table 1120 and the execution state position 1110, respectively. Moreover, when the states 509, 513, 515 are reached, the corresponding records of the message ID table 1120 are made empty (unused). That is, “−1” is stored in the execution state position storage area 703.

In step 1305, the execution state position is modified to state 1099. That is, a value indicating state 1099 is set in the execution state storage area 1100.

When the command processing device 301 receives the packet 901, steps 403, 404, 405 in the flowchart of FIG. 2 are repeated once. The execution state position in FIG. 8 is changed from 1001 to 1002, 1003, 1004, 1005, 1006, 1007, 1008. In the flowchart of FIG. 10, control is passed to steps 1200, 1201, 1202, 1203, 1204, 1205, 1207 and furthermore, the state is changed to 1009, 1010, 1011, 10121, 1013. At this moment, the value stored in the payload storage areas 1105, 1106 is “8” and the steps 1301, 1302, 1303, 1304 of FIG. 11 are repeated eight times. As a result, the same processing as when the packet 601 is received is performed, thereby executing the illumination ON/OFF control.

Similarly, when the command processing device 301 receives the packet 902, the steps 403, 404, 405 of the flowchart in FIG. 2 are repeated once. The execution state position shown in FIG. 8 is successively changed from 1001 to 1002, 1003, 1004, 1005, 1006, 1007, 1008. In the flowchart of FIG. 10, control is passed to step 1200, 1201, 1202, 1203, 1204, 1205. 1207 and the execution state position is further changed successively to 1009, 1010, 1011, 1012, 1013. At this moment, the value stored in the payload storage areas 1105, 1106 is “4” and the steps 1301, 1302, 1303, 1304 of FIG. 11 are repeated four times.

After this, when the command processing device 301 receives the packet 903, the steps 403, 404, 405 of the flowchart in FIG. 2 are repeated once. The execution state position shown in FIG. 8 is changed from 1001 to 1002, 1003, 1004, 1005, 1006, 1007, 1008. In the flowchart of FIG. 10, control is passed to steps 1200, 1202, 1202, 1207. Furthermore, the execution state position is changed to 1009, 1010, 1011, 1012, 1013. At this moment, the value stored in the payload storage areas 1105, 1106 is “4” and the steps 11301, 1302, 1303, 1304 of FIG. 11 are repeated four times. As a result, by combining the packet 902 and the packet 903, the same processing as when the packet 601 is received is performed, thereby performing the illumination ON/OFF control.

It should be noted that the command processing device 301 in this embodiment also operates correctly even when another packet is received during processing of a fragmented packet (for example, packets are received in the order of packets 902, 901, 903). Moreover, the command processing device 301 of this embodiment requires a storage area of the variable memory 3234 of a small storage capacity as compared to the entire packet size even when processing simultaneously plenty of packets and processing packet whose entire size is unknown.

According to the command processing device 301 of this embodiment, for example, when receiving command data fragmented by the packet communication according to a protocol such as the TCP/IP, the state in the state transition pattern is correlated to the message ID as identification information added to the command data and stored. Accordingly, for the command data divided into a plurality of element data groups, it is possible to successively change the state. Consequently, the command processing device 301 can proceed interpretation of the command data divided into a plurality of parts without waiting for receiving all the element data constituting the command data. Moreover, when the command processing device 301 receives command data divided via a network containing command data from a plurality of transmission sources, a plurality of command data fragments may be mixed when transmitted. In this case also, the command processing device 301 of this embodiment can proceed interpretation of command data without waiting for receiving the entire command data.

Moreover, in general, when the command processing device 301 receives the fragment packet, firstly, all the fragmented packets are received and they are concatenated on the memory and interpretation is performed. However, when the first fragmented packet of a fragmented packet is received, the packet size before the division is unknown and a very large memory buffer should be prepared. In the command processing device 301 of the present embodiment, when the head data of the fragmented first packet is received, packet interpretation is started immediately. For this, the time between the packet reception and the actual device operation start is significantly reduced, and it is possible to obtain a sufficient performance even in a small size processor. Moreover, regardless of the previous packet size before fragmentation, packet interpretation processing can be performed in a small storage capacity of the variable memory 323.

As has been described above, according to the command processing device 301 of this embodiment, it is possible to reduce the capacity of the variable memory required for communication reception processing. Moreover, even a low-processing capacity processor can rapidly interpret a packet. Accordingly, it is possible to realize a command processing device 301 of small size, low power consumption, and low cost.

According to the command processing device 301 of this embodiment, especially in the communication protocol processing in the processor, the processor can successively process the packets almost without transferring the packets to the variable memory 323. Consequently, it is possible to reduce the storage capacity of the variable memory 323 to be owned by the command processing device 301. Thus, it is possible to reduce the size of the command processing device 301 and realize operation with a low power consumption. Moreover, by successively interpreting parts of a packet, it is possible to reduce the response time. For this, even when a small-size processor is used, it is possible to realize a high-speed response. Moreover, it is possible to reduce the size of the command processing device 301.

As has been described above, according to the command processing device 301 of this embodiment, it is possible to realize the command processing device 301 of small size, lower power consumption, and low cost.

### Modified Example

The aforementioned embodiments are only examples of the embodiments of this invention and they can be modified within the range of this invention. Hereinafter, a modified example is described.

In the aforementioned embodiments, the command processing device 301 is applied to an illumination device as an example. However, it can also be applied to, for example, a head set, a mobile game device, and other mobile electronic devices, Moreover, the device, even small in size, may be a stand alone type electronic device.

In the aforementioned embodiments, a unique packet format is used, but the present invention can also be applied in the same way, for example, to analysis processing such as address processing, fragment processing, upper node protocol processing for the TCP/IP (Transmission Control Protocol/Internet Protocol) and HTTP (Hyper Text Transfer Protocol). By applying this invention to IP packet analysis of the TCP/IP protocol, it is possible to transmit command data to the command processing device 301 by using the widely used TCP/IP protocol without using a special protocol.

Moreover, the command processing sensor 301 can have a connection section for connection to, for example, to a sensor such as a human sensitive sensor, a temperature sensor, a humidity sensor, and a gas leak sensor. In this case, the command processing device 301 receives the sensor detection result and can transmit the detection result to the control device 310 via the radio network 309. It is also possible to build in the command processing device 301 in these sensors.

Moreover, it is possible to provide an output device such as an LED, a buzzer, and a liquid crystal display in the command processing device 301. Thus, the command processing device 301 can output the sensor detection result to the output device in addition to notification via the network.

It should be noted that the command processing device 301 and the device connected to it can be made into a physically unitary block.

It should be further understood by those skilled in the art that although the foregoing description has been made on embodiments of the invention, the invention is not limited thereto and various changes and modifications may be made without departing from the spirit of the invention and the scope of the appended claims.

1. A command processing device comprising:
a command reception section for receiving command data formed by a plurality of element data transmitted from an information processing device by successively receiving the element data;
a state transition pattern storage section for storing a processing state transition pattern in an interpretation process of the command data;
a state transition section for processing the element data one by one in the interpretation process of the command data and changing the processing state in the interpretation process according to the state transition pattern each time one element data is processed; and
a control section for executing control according to the state finally decided by the state transition section.

2. A command processing device as claimed in claim 1, further comprising an element data storage section for storing element data received by the command reception section,
wherein the element data storage section stores only a part of a plurality of element data constituting the command data.

3. A command processing device as claimed in claim 1, further comprising a state storage section for storing the state to be changed by the state transition section while correlating it to the identification information added to the command data,
wherein the command reception section receives the command data divided into a plurality of element data groups by successively receiving the element data one by one for each of the element data groups, and
the state transition section reads out a state corresponding to the identification information added to each of the element data group, changes the read out state according to the state transition pattern, and stores the state changed in the state storage section.

4. A command processing device as claimed in claims 1, further comprising a radio communication interface for performing communication via radio,
wherein the command reception section receives the element data via the radio communication interface.

5. A command processing device as claimed in claim 3, wherein the command reception section receives the command data as an IP datagram according to the TCP/IP protocol, and
the identification information is an identifier specified for a header portion of the IP datagram received via the communication path by the reception section.

6. A command processing device as claimed in claim 1, further comprising a communication interface communicably connected to a home electric appliance,
wherein the control section controls operation of the home electric appliance via the communication interface according to the state finally decided by the state transition section.

7. A command processing device as claimed in claim 6, the device further comprising a transmission section for transmitting data to the information processing device via the communication path,
wherein the control section receives information from the home electric appliance via the interface according to the state finally decided by the state transition section and transmits information received from the home electric appliance via the transmission section to the information processing device.

8. A command processing device as claimed in claim 1, further comprising:
a communication interface for connection with a sensor device; and
a transmission section for transmitting data to the information processing device via the communication path,
wherein the control section receives a detection result of the sensor via the communication interface, and
the control section transmits the detection result via the transmission section to the information processing device according to the state finally decided by the state transition section.

9. A command processing device as claimed in claim 2, further comprising:
a communication interface for connection with a sensor device; and
a transmission section for transmitting data to the information processing device via the communication path,
wherein the control section receives a detection result of the sensor via the communication interface, and
the control section transmits the detection result via the transmission section to the information processing device according to the state finally decided by the state transition section.

10. A control method of a command processing device comprising a processor, a memory, a communication interface for communication with an information processing device, and a control section for controlling a controllable device, the method comprising steps of:
receiving, by the communication interface, command data formed by a plurality of element data transmitted from an information processing device by successively receiving the element data;
storing, by the memory, a processing state transition pattern in an interpretation process of the command data;
successively processing, by the processor, the element data one by one in the interpretation process of the command data and changing the processing state in the interpretation process according to the state transition pattern each time one element data is processed; and
executing, by the control section, control decided according to a state finally decided by the transition by the state transition pattern.
